(19) United States
(12) Patent Application Publication
(10) Pub. No.: US 2008/0270613 A1
(43) Pub. Date: Oct. 30, 2008

(54) Method of Processing a Contact for a Mobile Device and Related Device

(76) Inventors: Drew Bamford, Taoyuan County (TW); Martijn Van Tilburg, Taoyuan County (TW); Rob Girling, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/109,336

(22) Filed: Apr. 24, 2008

Related U.S. Application Data
(60) Provisional application No. 60/914,324, filed on Apr. 27, 2007.

(51) Int. Cl. G06F 15/16; G06F 17/30; G06F 3/00

(52) U.S. Cl. 709/227; 707/1; 715/746; 707/E17.001

(57) ABSTRACT

To add a contact to a mobile device, the mobile device displays a login screen for a first online service, logs into the first online service based on a username and password, retrieves a contact list from the first online service which has a first contact identifier, utilizes the first contact identifier as a search term for finding a second contact identifier on a second online service, and adds the contact including the first contact identifier and the second contact identifier to the mobile device.

### CROSS REFERENCE TO RELATED APPLICATIONS

This application claims the benefit of U.S. Provisional Application No. 60/914,324, filed on Apr. 27, 2007 and entitled “Automatic Import of Contacts and Related Contact Feeds,” the contents of which are incorporated herein by reference.

### BACKGROUND OF THE INVENTION

1. Field of the Invention

The present invention relates to methods of importing contacts, and more particularly, to a method of processing a contact including multiple contact identifiers for a mobile device and related device.

2. Description of the Prior Art

Dramatic improvements in electronics technology have ushered in the current digital information age, in which people across the globe use devices that fit in the palm of your hand to schedule their lives with personal calendar and alert systems, find their exact location cross-referenced to local maps with tourist information, communicate with each other via voice and email, and access vast data storage houses holding information on nearly any subject known to man. Tasks which once required wired connections to telephone networks and databases are now available through wireless networks, meaning that people can perform any of these tasks anywhere they can find a cellular signal or wireless hotspot.

Typical devices capable of interacting with such wireless networks include personal digital assistants (PDAs), mobile phones, and smartphones, which may be considered a hybrid of the two. A typical smartphone will be equipped to access mobile communications networks, such as a GSM network, for voice and data transfer, as well as IEEE 802.11-type networks. Both the mobile communications network and the 802.11-type network may be utilized to access the Internet, including all data and services provided thereon. The smartphone may also include PDA-type functions, such as a calendar/scheduler, an address book/contact list, a notepad, and a dictionary, to name a few.

The address book, or contact list, has traditionally been used to store information about an individual or organization, including a home phone number, office phone number, and mobile phone number. More recently, with the growing popularity, and now ubiquity, of email as a form of communication, contact lists are now further enhanced with email addresses and web addresses of individuals and organizations. This is particularly useful as even the simplest of mobile phones, not to mention smartphones, is capable of sending email through the GPRS Core Network. Of course, the smartphone may also obtain an IP from a wireless access point and send email directly, or use a web browser to browse the web address provided in the contact list.

In addition to email services, messaging services and social networking services are also springing up rapidly as developers take advantage of greater connection speeds and more powerful host servers. Thus, in addition to the phone numbers and email addresses mentioned above, the individual or organization may also have user IDs for multiple messaging services and social networking services. In this instance, the strength of the digital information age, i.e. its sheer volume of digital information and services, becomes one of its greatest weaknesses. If a smartphone owner were to attempt to use the smartphone's browser interface to access each messaging service and each social networking service to find every user ID for all of the numerous individuals and organizations in his/her contact list, the process could take hours, if not days, not to mention the fact that not every individual and organization will even have a user ID for all of the messaging services and social networking services. Further, the smartphone owner may not have entered all of his/her contacts in the contact list. In other words, there is no way for the smartphone owner to ensure that his/her contacts are synchronized across each online service. Thus, the prior art is neither user-friendly nor robust.

### SUMMARY OF THE INVENTION

According to a first embodiment of the present invention, a method of storing a first contact identifier obtained when retrieving a contact list from a first server and a second contact identifier obtained when searching for the first contact identifier on a second server in a mobile device comprises storing the first contact identifier after the first contact identifier is received, and storing the second contact identifier after the second contact identifier is received.

According to another embodiment of the present invention, a mobile device for storing contact identifiers comprises a network interface for establishing a data connection with a first server for obtaining a contact list comprising a first contact identifier, and a non-volatile memory storing the first contact identifier, contact identifier search code, and contact identifier storing code. The mobile device further comprises a processor coupled to the network interface and the non-volatile memory for executing the contact identifier search code for controlling the network interface to establish a data connection with a second server and send a search request comprising the first contact identifier to the second server, and storing a second contact identifier in the non-volatile memory when the network interface receives the second contact identifier in response to the search request.

According to a second embodiment of the present invention, a method for processing a contact for a mobile device comprises displaying a login interface corresponding to a first online service, and displaying a contact list including a first representation of a first contact identifier corresponding to the contact, and a second representation indicating existence of a second contact identifier corresponding to the contact for a second online service.

According to yet another embodiment of the present invention, a mobile device for processing a contact comprises a display, a non-volatile memory storing contact adding code, and a processor for executing the contact adding code for controlling the display to display a login interface corresponding to a first online service, and controlling the display to display a contact list including a first representation of a first contact identifier corresponding to the contact, and a second representation indicating existence of a second contact identifier corresponding to the contact for a second online service.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a process for processing a contact for a mobile device according to the present invention.

FIGS. 2-5 are diagrams of an interface for processing contacts for a mobile device according to the present invention.

FIG. 6 is a diagram of a mobile device according to the present invention.

### DETAILED DESCRIPTION

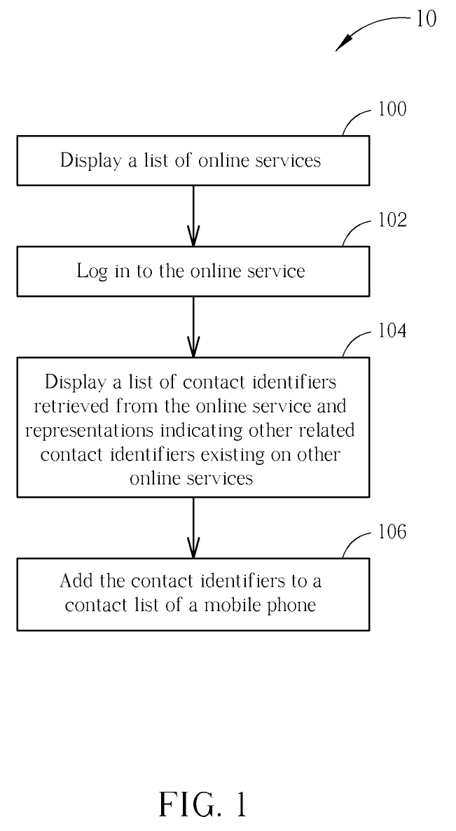

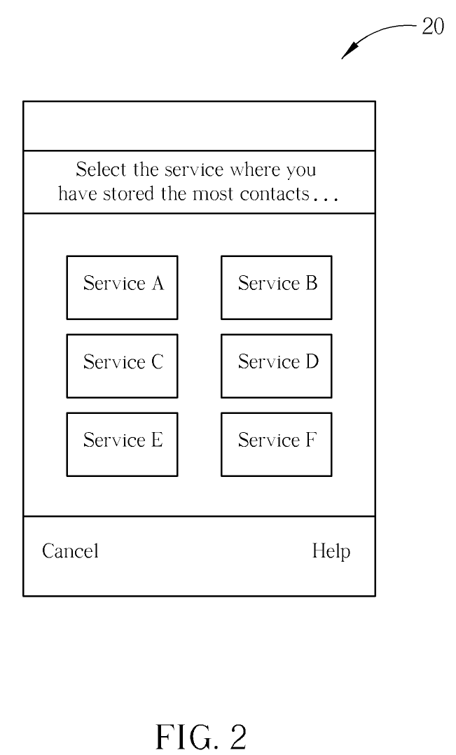

Please refer to FIGS. 1-5. FIG. 1 is a flowchart of a process 10 for processing a contact for a mobile device according to the present invention, and FIGS. 2-5 are diagrams of an interface that could be utilized to realize the process 10 in the mobile device. To overcome the need for manual browsing and input of contact identifiers in the prior art, the present invention provides a method for adding contacts which starts with displaying a list of online services in the mobile device. As shown in FIG. 2, the mobile device displays six icons corresponding to six different online services Services A-F (Step 100) in a first interface screen 20. The number six is not representative of a limitation of the present invention method, and any number of online services could be represented by a corresponding number of icons in the first interface screen 20. The services may be email services, social networking services, telephone directories, etc. Any online service that a user has access to and has stored a contact list on may be utilized in the present invention. Any number and combination of the above-mentioned services may be utilized for Step 100 as well.

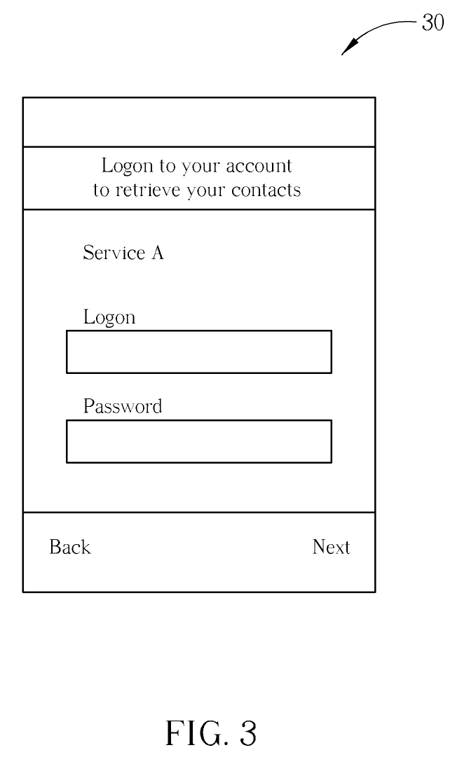

Upon selection of one of the services through the first interface screen 20, the mobile device may display a login interface screen 30, shown in FIG. 3, corresponding to the online service selected, and the mobile device may log in to the online service selected with a username and password provided by the user or stored in the mobile device (Step 102). The username and password may be entered through an input device, or may be stored on the mobile device in a cookie or other file in non-volatile memory. The online service selected may be seen as a first online service, and may be served by a first server, with the username and the password corresponding to a first account of the user.

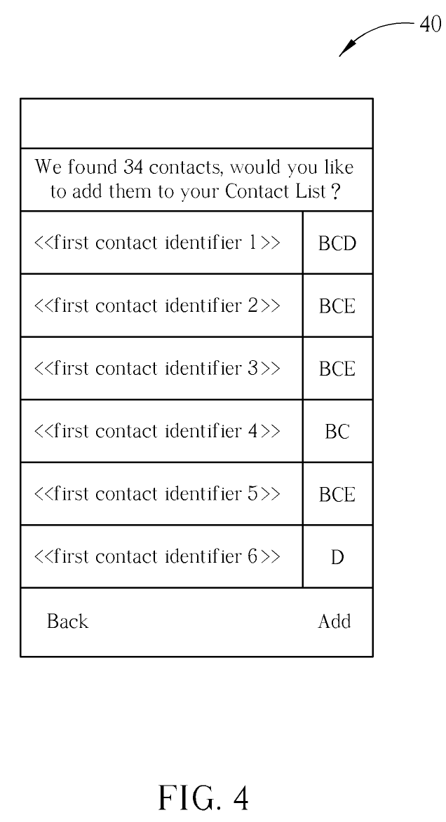

Once the mobile device has logged in to the first server, the mobile device may retrieve a contact list corresponding to the first account from the first server upon request. FIG. 4 shows a contacts selection interface screen 40, which may be utilized by the mobile device to display the contact list corresponding to the first account that is retrieved from the first server (Step 104). As shown in FIG. 4, the contact list retrieved from the first server includes at least one first representation corresponding to at least one first contact identifier (first contact identifiers 1-6) for each contact. In other words, if the first contact identifier 1 from the first online service is an email address, the email address may be shown in full, shown as an abbreviation, or represented with an icon, etc. Of course, the first contact identifier may be an email address, a phone number, an account ID, a nickname, or even a hyperlink to a website corresponding to the contact.

Corresponding to each of the first contact identifiers, second representations of second contact identifiers are also shown. For example, the mobile device may retrieve the contact list from the online service Service A. In this case, each of the first contact identifiers 1-6 may be related to the online service Service A. Then, depending on which other online services the contact may have signed up for, if the contact has also signed up for the online service Service B, namely a second online service, then the contacts selection interface screen 40 may display a second representation indicating existence of the second contact identifier, or a second account, located on the second online service corresponding to the contact. For example, as shown in FIG. 4, a first contact having the first contact identifier 1 also has second contact identifiers on Services B, C, and D. A second contact having the first contact identifier 2 may have second contact identifiers on Services B, C, and E, and so on. Of course, each contact having a first contact identifier may be shown regardless of whether or not a second contact identifier exists for the contact. And, as mentioned above for the first representations of the first contact identifiers, the second representations of the second contact identifiers may also be the second contact identifiers shown in full, shown as an abbreviation, shown as an image, such as an icon, or shown as text. Preferably, the present invention shows the first contact identifier in full or abbreviated, and the second contact identifier or identifiers as icons. The second contact identifier(s) may also be an email address, a phone number, an account ID, a nickname, or a hyperlink to a website corresponding to the contact.

The contacts selection interface screen 40 also asks the user whether or not he/she desires to add the contacts to the mobile phone. At this point, the user may decide to add all of the contacts found with all of the first contact identifiers and second contact identifiers, or the user may selectively remove entire contacts, first contact identifiers, or second contact identifiers from the list at his/her discretion. By default, all contacts including the first contact identifiers and all second contact identifiers may be selected.

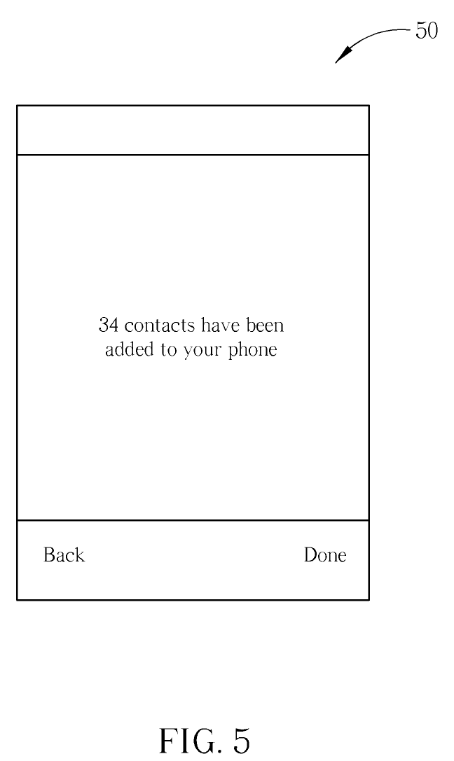

In FIG. 5, once the user confirms addition of the contacts shown in FIG. 4, the mobile device displays a contact addition confirmation screen 50, which indicates that the mobile phone has added the contacts, including the first contact identifier and any and all second contact identifiers selected, to the mobile phone (Step 106). It is possible that some contacts of the contact list may already be stored partially or in full in the mobile device. For example, the address book of the mobile device may already have one of the first contact identifiers or one of the second contact identifiers listed under an existing contact in the address book. In this case the present invention may automatically update the existing contact with any of the first contact identifiers and second contact identifiers not found in the address book.

In the above, description was omitted for how the mobile device may determine, or obtain information on, the second contact identifiers corresponding to each contact. In Step 102, the mobile device may establish a data connection with the first server, and download the contact list from the first server. Then, prior to Step 104, the mobile device may extract the first contact identifier from the contact list, and utilize the first contact identifier as a search term or parameter sent to a second server through a data connection established with the second server. The second server may correspond to the second online service. The second contact identifier may then be extracted from a response of the second server to the search request sent by the mobile device. This process of logging onto second servers to search for corresponding second contact identifiers based on the first contact identifier may be repeated for each online service that the user is interested in searching through. The mobile device may have a preset list of online services for searching for second contact identifiers. The mobile device may also take input from the user to determine which online services to search for the second contact identifiers. Further, the second contact identifier(s) found may also be utilized as the search term or parameter for subsequent searches performed on other online services.

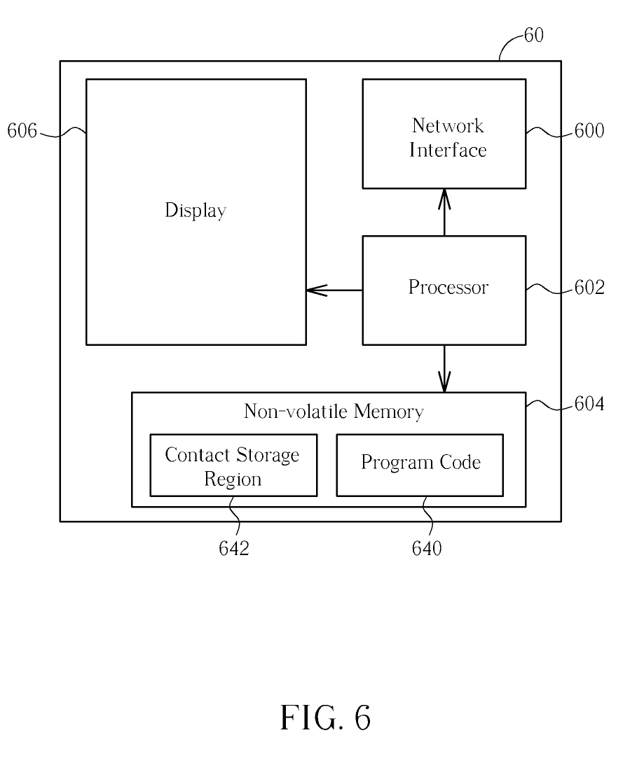

Please refer to FIG. 6, which is a diagram of a mobile device 60 according to the present invention. The mobile device 60 comprises a network interface 600 for establishing a data connection with the first server or the second server(s), a processor 602 for executing program code 640 stored in a non-volatile memory 604 of the mobile device 60, and a display 606 for displaying a user interface, such as the first interface screen 20, the login interface screen 30, the contacts selection interface screen 40, and the contact addition confirmation screen 50 described above. The processor 602 is coupled to the network interface 600, the non-volatile memory 604, and the display 606 for executing the program code for controlling the network interface 600 to establish a data connection with the second server and send the search request comprising the first contact identifier to the second server, and for storing a second contact identifier in the non-volatile memory 604 when the network interface 600 receives the second contact identifier in response to the search request. The processor 602 may also control the display 606 to display a login interface corresponding to the first online service, and control the display 606 to display the contact list including the first representation of the first contact identifier corresponding to the contact and the second representation indicating existence of the second contact identifier corresponding to the contact for the second online service. The non-volatile memory 604 may comprise a contact storage region 642 for storing the contact including the first contact identifier and the second contact identifier(s). The mobile device 60 may also comprise an input device coupled to the processor 602 for inputting parameters, such as the username and password mentioned above, in which case the processor may control the network interface 600 for logging into the first server with the parameter. The network interface 600 may be a GPRS modem or an IEEE 802.11-type transceiver. Of course, any other network interface capable of establishing a data connection with the first server and the second server(s) is applicable in the present invention.

Compared to the prior art, the present invention provides a method and related mobile device that allows for rapid, robust addition of contacts, including a first contact identifier corresponding to a first online service, and second contact identifiers corresponding to second online services. Whereas the prior art required manual addition of contacts, and manual enhancement of contacts, both of which are time-consuming, cumbersome, and non-robust, the present invention provides automatic lookup and addition of robust, enhanced contacts through a very simple user interface that may be integrated into any mobile device with network connectivity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of storing a first contact identifier obtained when retrieving a contact list from a first server and a second contact identifier obtained when searching for the first contact identifier on a second server in a mobile device, the method comprising:
storing the first contact identifier after the first contact identifier is received; and
storing the second contact identifier after the second contact identifier is received.

2. The method of claim 1, further comprising creating a new contact, wherein storing the first contact identifier is storing the first contact identifier under the new contact, and storing the second contact identifier is storing the second contact identifier under the new contact.

3. The method of claim 1, further comprising:
utilizing a first account to log onto the first server; and
obtaining the contact list corresponding to the first account from the first server.

4. The method of claim 3, wherein utilizing the first account to log onto the first server is utilizing a username and a password corresponding to the first account to log onto the first server.

5. The method of claim 4, wherein utilizing the username and password to log onto the first server is utilizing the username and password to log onto an email server.

6. The method of claim 1, further comprising:
performing the search on the second server for the first contact identifier;
receiving a result of the search; and
obtaining the second contact identifier from the result of the search.

7. The method of claim 6, wherein performing the search on the second server for the first contact identifier is performing the search on the second server for an email address.

8. The method of claim 6, wherein performing the search on the second server for the first contact identifier is performing the search on a social network server for the first contact identifier.

9. The method of claim 1, wherein storing the first contact identifier is storing an email address.

10. The method of claim 1, wherein storing the second contact identifier is storing an account number.

11. The method of claim 1, wherein storing the second contact identifier is storing a nickname.

12. The method of claim 1, wherein storing the second contact identifier is storing a phone number.

13. The method of claim 1, further comprising storing a hyperlink corresponding to the second contact identifier.

14. A mobile device for storing contact identifiers, the mobile device comprising:
a network interface for establishing a data connection with a first server for obtaining a contact list comprising a first contact identifier;
a non-volatile memory storing the first contact identifier, contact identifier search code, and contact identifier storing code; and
a processor coupled to the network interface and the non-volatile memory for executing the contact identifier search code for controlling the network interface to establish a data connection with a second server and send a search request comprising the first contact identifier to the second server, and storing a second contact identifier in the non-volatile memory when the network interface receives the second contact identifier in response to the search request.

15. The mobile device of claim 14, further comprising an input device coupled to the processor for inputting a parameter, wherein the processor is for controlling the network interface for logging into the first server with the parameter.

16. The mobile device of claim 14, wherein the network interface is a GPRS modem.

17. The mobile device of claim 14, wherein the network interface is a wireless network interface.

18. The mobile device of claim 14, wherein the first contact identifier is an email address.

19. A method for processing a contact for a mobile device, the method comprising:
displaying a login interface corresponding to a first online service; and
displaying a contact list including a first representation of a first contact identifier corresponding to the contact, and a second representation indicating existence of a second contact identifier corresponding to the contact for a second online service.

20. The method of claim 19, further comprising:
logging into the first online service according to logon and password information inputted to the login interface.

21. The method of claim 19, further comprising:
adding the contact.

22. The method of claim 21, wherein adding the contact comprises adding the first contact identifier and the second contact identifier.

23. The method of claim 22, wherein adding the first contact identifier and the second contact identifier is adding an email address and the second contact identifier.

24. The method of claim 23, wherein adding the email address and the second contact identifier is adding the email address and a messaging service identifier.

25. The method of claim 23, wherein adding the email address and the second contact identifier is adding the email address and a nickname.

26. The method of claim 21, wherein displaying the contact list comprises displaying an online status of the contact in the contact list.

27. The method of claim 19, wherein displaying the login interface corresponding to the first online service is displaying the login interface corresponding to an email service.

28. A mobile device for processing a contact, the mobile device comprising:
a display;
a non-volatile memory storing contact adding code; and
a processor for executing the contact adding code for controlling the display to display a login interface corresponding to a first online service, and controlling the display to display a contact list including a first representation of a first contact identifier corresponding to the contact, and a second representation indicating existence of a second contact identifier corresponding to the contact for a second online service.

29. The mobile device of claim 28, further comprising:
a network interface for establishing a data connection with a first server corresponding to the first online service for logging into the first online service according to logon and password information inputted to the login interface.

30. The mobile device of claim 28, wherein the non-volatile memory further comprises a contact storage region for storing the contact.

31. The mobile device of claim 30, wherein the first contact identifier and the second contact identifier are stored in the contact storage region.

32. The mobile device of claim 31, wherein the first contact identifier is an email address.

33. The mobile device of claim 32, wherein the second contact identifier is a messaging service identifier.

34. The mobile device of claim 32, wherein the second contact identifier is a nickname.

35. The mobile device of claim 30, wherein the display is for displaying an online status of the contact in the contact list.

36. The mobile device of claim 28, wherein the display is for displaying the login interface corresponding to an email service.
